(19) United States
(12) Patent Application Publication
(10) Pub. No.: US 2025/0162072 A1
(43) Pub. Date: May 22, 2025

(54) JIG FOR LASER NOTCHING OF SECONDARY BATTERY ELECTRODE AND APPARATUS AND METHOD FOR LASER NOTCHING SECONDARY BATTERY ELECTRODE

(71) Applicant: SAMSUNG SDI CO., LTD., Yongin-si (KR)

(72) Inventor: Kyu Chul CHOI, Suwon-si (KR)

(21) Appl. No.: 18/756,644

(22) Filed: Jun. 27, 2024

(30) Foreign Application Priority Data
Nov. 20, 2023 (KR) 10-2023-0159967

(51) Int. Cl. B23K 26/10; B23K 26/08; B23K 26/38; B23K 101/36

(52) U.S. Cl. CPC B23K 26/10; B23K 26/0869; B23K 26/38; B23K 2101/36

(57) ABSTRACT

A jig for laser notching of secondary battery electrodes and an apparatus and method for laser notching secondary battery electrodes are disclosed. A jig for laser notching of secondary battery electrodes includes: a first plate to support a secondary battery electrode; and a second plate overlapping the first plate to press the secondary battery electrode therebetween toward the first plate, the second plate comprising a laser passage to partially expose the secondary battery electrode to allow a laser beam to be delivered to the secondary battery electrode therethrough. Upon laser notching of a secondary battery electrode, the jig can secure the secondary battery electrode in an unbent state.

### CROSS-REFERENCE TO RELATED APPLICATION

The present application claims priority to and the benefit of Korean Patent Application No. 10-2023-0159967, filed on Nov. 20, 2023 in the Korean Intellectual Property Office, the entire disclosure of which is incorporated herein by reference.

### BACKGROUND

### 1. Field

Aspects of embodiments of the present disclosure relate to a jig for laser notching of secondary battery electrodes and an apparatus and method for laser notching secondary battery electrodes.

### 2. Description of the Related Art

In general, with rapid increase in demand for portable electronics, such as notebook computers, video cameras, and portable phones, and commercialization of robots and electric vehicles, various studies have been actively carried out to develop high-performance secondary batteries that allow repeated charge and discharge.

A secondary battery includes an electrode assembly, which includes a cathode and an anode, that is, a pair of secondary battery electrodes, and a separator interposed between the secondary battery electrodes. Each of the secondary battery electrodes includes an electrode plate including a thin metal foil and an electrode active material applied to one or both surfaces of the electrode plate.

In the secondary battery electrode, a region not coated with an electrode active material is referred to as a non-coated portion, and a region coated with the electrode active material is referred to as a coated portion. A process of partially cutting the non-coated portion to form tabs on the secondary battery electrode and remove an unnecessary portion therefrom is referred to as notching of the secondary battery electrode.

Methods for notching a secondary battery electrode include, for example, a method of cutting the secondary battery electrode by pressing the secondary battery electrode with a punch (herein referred to as press notching) and a method of cutting the secondary battery electrode by irradiating the secondary battery electrode with a laser beam (herein referred to as laser notching). In production of many types of secondary battery electrodes in small quantities, laser notching may be more advantageous than press notching for cost reduction and rapid product supply.

The above information disclosed in this Background section is provided for enhancement of understanding of the background of the present disclosure, and, therefore, it may contain information that does not constitute related (or prior) art.

### SUMMARY

According to aspects of embodiments of the present disclosure, a jig for laser notching of secondary battery electrodes, which supports and holds a secondary battery electrode upon laser notching of the secondary battery electrode, and an apparatus and method for laser notching secondary battery electrodes are provided.

These and other aspects and features of the present disclosure will be described in or will be apparent from the following description of some embodiments of the present disclosure.

According to one or more embodiments of the present disclosure, a jig for laser notching of secondary battery electrodes includes: a first plate to support a secondary battery electrode; and a second plate overlapping the first plate to press the secondary battery electrode therebetween toward the first plate, the second plate comprising a laser passage to partially expose the secondary battery electrode to allow a laser beam to be delivered to the secondary battery electrode therethrough.

The jig may further include: a base including at least one spacer supporting the first plate and a spacer support supporting the at least one spacer.

The jig may further include at least one fastening bolt coupling the at least one spacer to the first plate, wherein the secondary battery electrode does not contact the fastening bolt when the secondary battery electrode is arranged between the first plate and the second plate.

The fastening bolt may include a bolt body penetrating the first plate in a thickness direction thereof and having a first end inserted in the spacer, and a bolt head formed at a second end of the bolt body and having a greater diameter than the bolt body, wherein the first plate includes an electrode support surface with which the secondary battery electrode is contactable; and a bolt head seating groove is located on the electrode support surface to allow the bolt head to be seated therein so as not to contact the secondary battery electrode.

The first plate may include at least one spacer seating groove in which the at least one spacer is seated.

The at least one spacer may include a plurality of spacers arranged to overlap each other along a straight line parallel to a direction in which the first plate, the secondary battery electrode, and the second plate overlap one above another.

The first plate may include a first plate aperture aligned with the laser passage and penetrating the first plate in a thickness direction thereof.

The base may further include a scrap tray to collect scraps cut from the secondary battery electrode and discharged from the first plate through the first plate aperture, the scrap tray being detachably supported on the spacer support or the at least one spacer.

The laser passage may include a laser aperture penetrating the second plate in a thickness direction thereof.

The laser aperture may have a closed curve planar shape.

The laser aperture may have a line shape extending with a constant width in a plan view.

The first plate may be formed with a first plate aperture aligned with the laser aperture and penetrating the first plate in a thickness direction thereof, and the first plate aperture may have a same planar shape as the laser aperture.

If the second plate is placed on the first plate, the second plate may be pulled toward the first plate.

One of the first plate and the second plate may include a magnet, and the other of the first plate and the second plate may include a ferromagnetic material.

One of the first plate and the second plate may include a plurality of guide pins protruding therefrom toward the other of the first plate and the second plate, and the other of the first plate and the second plate may be formed with a plurality of guide apertures or a plurality of guide grooves into which the plurality of guide pins is inserted when the first plate and the second plate overlap each other.

The second plate may include a gripping portion protruding outward beyond a boundary of an outer circumference of the first plate to be gripped upon separation of the second plate from the first plate.

According to one or more embodiments of the present disclosure, an apparatus for laser notching secondary battery electrodes includes: a jig for laser notching of secondary battery electrodes, the jig including a first plate to support a secondary battery electrode, and a second plate overlapping the first plate to press the secondary battery electrode therebetween toward the first plate, the second plate comprising a laser passage to partially expose the secondary battery electrode; and a laser head configured to project a laser beam toward the second plate to be delivered to the secondary battery electrode through the laser passage.

The jig may further include: at least one spacer supporting the first plate to allow a gap between the first plate and the laser head to be adjusted; and a spacer support supporting the at least one spacer.

The laser head may be movable in a direction approaching the first plate and in another direction away from the first plate such that a gap between the first plate and the laser head is adjusted.

According to one or more embodiments of the present disclosure, a method for laser notching secondary battery electrodes includes: preparing a jig for laser notching of secondary battery electrodes, the jig comprising a first plate and a second plate having a laser passage; arranging a secondary battery electrode between the first plate and the second plate and mounting the secondary battery electrode on the jig such that the first plate, the secondary battery electrode, and the second plate overlap one another; and projecting a laser beam toward the second plate to be delivered to the secondary battery electrode through the laser passage.

According to an aspect of embodiments of the present invention, upon laser notching of a secondary battery electrode, the secondary battery electrode is secured in a flat unbent state between the first plate and the second plate, and laser irradiation of the secondary battery electrode is not interrupted, thereby improving quality and work reliability of laser notching of the secondary battery electrodes.

Further, according to an aspect of embodiments of the present invention, various combinations of laser notching tests can be performed easily and quickly by changing the secondary battery electrodes, a gap between the first plate and the laser head, power of a laser head, and a notching pattern. Accordingly, an optimal combination for laser notching of secondary battery electrodes can be obtained.

However, technical aspects and problems to be solved by the present disclosure are not limited to the above, and other aspects and problems not mentioned herein, and aspects and features of the present disclosure that would address such problems, will be clearly understood by those skilled in the art from the description of the present disclosure below.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a side view of an apparatus for laser notching secondary battery electrodes according to an embodiment of the present disclosure, showing a first plate, a second plate, and a secondary battery electrode spaced apart from one another;

FIG. 2 is a cross-sectional view taken along the line II-II of FIG. 1, showing the second plate placed on the first plate with the secondary battery electrode interposed therebetween;

FIG. 3 is a cross-sectional view taken along the line III-III of FIG. 1, showing the second plate placed on the first plate with the secondary battery electrode interposed therebetween;

FIG. 4 is a plan view of a first plate included in a jig for laser notching of secondary battery electrodes according to an embodiment of the present disclosure;

FIG. 5 is a bottom view of the first plate shown in FIG. 4;

FIG. 6 is a plan view of a second plate included in the jig for laser notching of secondary battery electrodes according to an embodiment of the present disclosure;

FIG. 7 is a bottom view of the second plate shown in FIG. 6;

FIG. 8 is a plan view of a base included in the jig for laser notching of secondary battery electrodes according to an embodiment of the present disclosure, with a scrap tray removed therefrom;

FIG. 9 is a plan view of a first plate included in a jig for laser notching of secondary battery electrodes according to another embodiment of the present disclosure;

FIG. 10 is a bottom view of the first plate shown in FIG. 9;

FIG. 11 is a plan view of a second plate included in the jig for laser notching of secondary battery electrodes according to the embodiment of FIG. 9;

FIG. 12 is a bottom view of the second plate shown in FIG. 11; and

FIG. 13 is a side view of an apparatus for laser notching secondary battery electrodes according to another embodiment of the present disclosure, showing a first plate, a second plate, and a secondary battery electrode spaced apart from one another.

### DETAILED DESCRIPTION

Herein, some example embodiments of the present disclosure will be described, in further detail, with reference to the accompanying drawings. The terms or words used in this specification and claims should not be construed as being limited to the usual or dictionary meaning and should be interpreted as having meanings and concepts consistent with the technical idea of the present disclosure based on the principle that the inventor can be his/her own lexicographer to appropriately define the concept of the term to explain his/her invention in the best way. The embodiments described in this specification and the configurations shown in the drawings are some of the embodiments of the present disclosure and do not represent all of the technical ideas, aspects, and features of the present disclosure. Accordingly, it is to be understood that there may be various equivalents and modifications that can replace or modify the embodiments described herein at the time of filing this application.

It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same,” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section, unless specified otherwise.

Throughout the specification, unless specified otherwise, each element may be singular or plural.

When an arbitrary element is referred to as being disposed (or located or positioned) “above” (or “below”) or “on” (or “under”) a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element or layer is referred to as being “on,” “connected to,” or “coupled to” another element or layer, it may be directly on, connected, or coupled to the other element or layer, or one or more intervening elements or layers may also be present.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list.

Throughout the specification, when “A and/or B” is stated, it means A, B, or A and B, unless specified otherwise. That is, “and/or” includes any or all combinations of a plurality of items enumerated. When “C to D” is stated, it means C or more and D or less, unless specified otherwise.

When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to be limiting of the present disclosure.

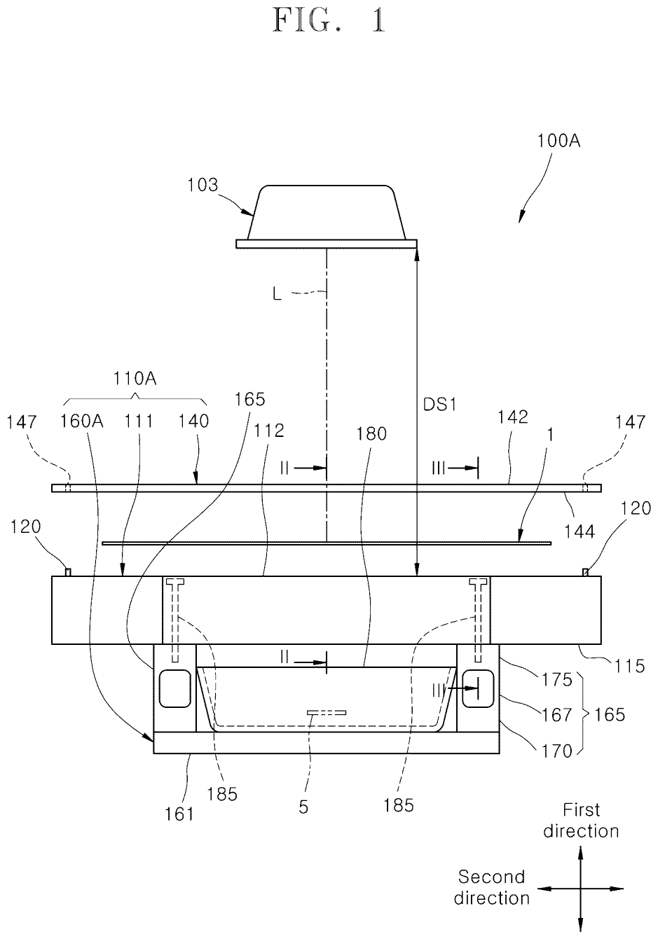

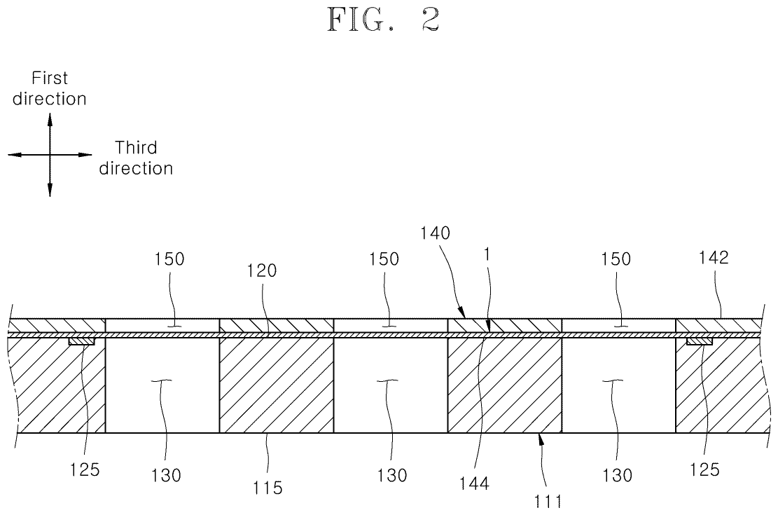

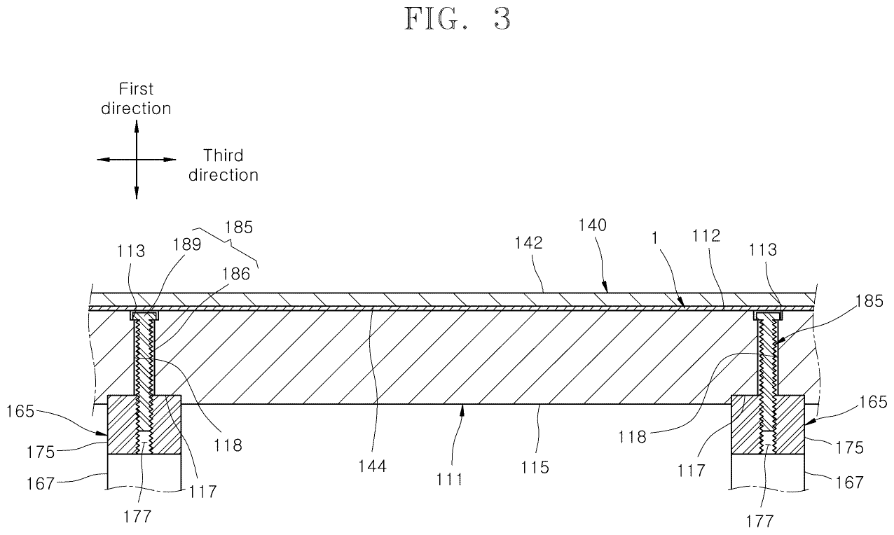

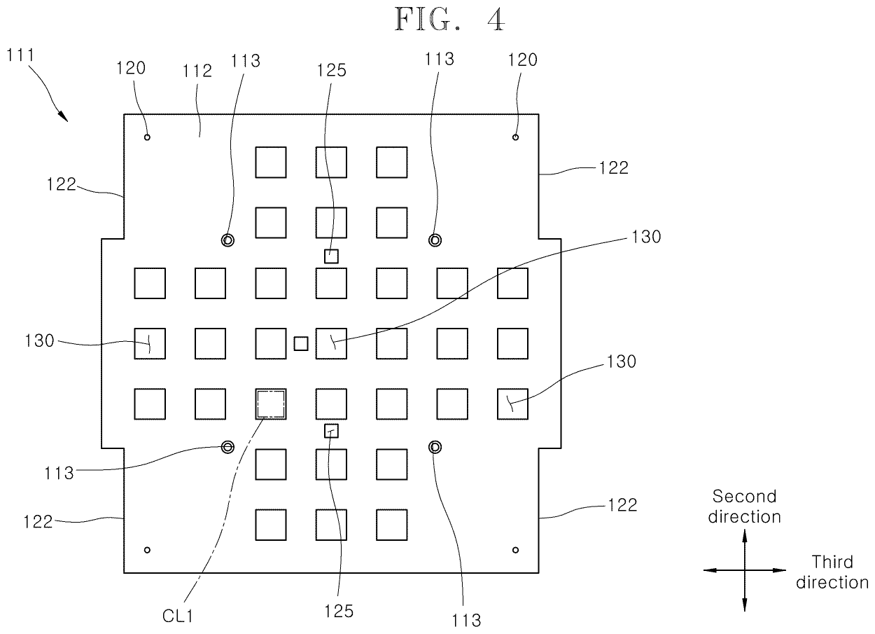

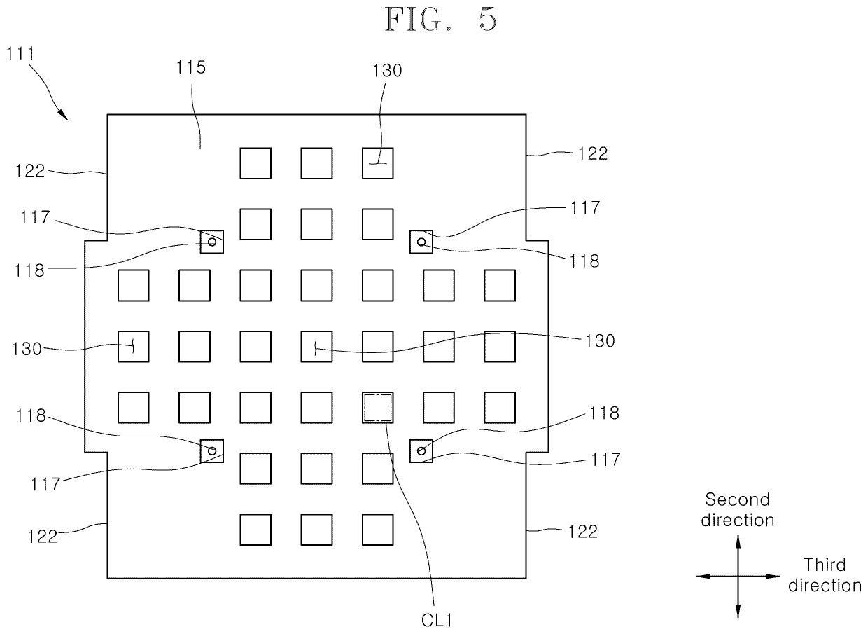

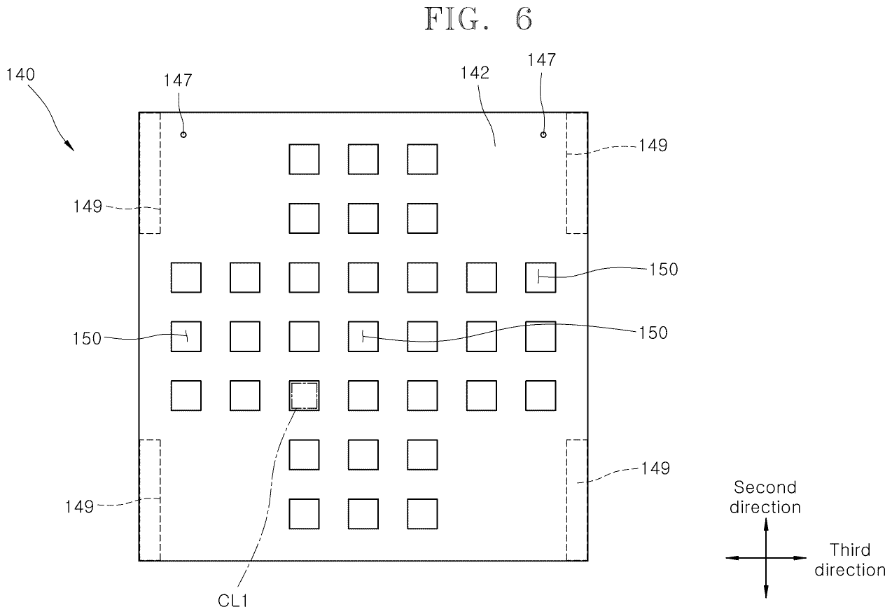

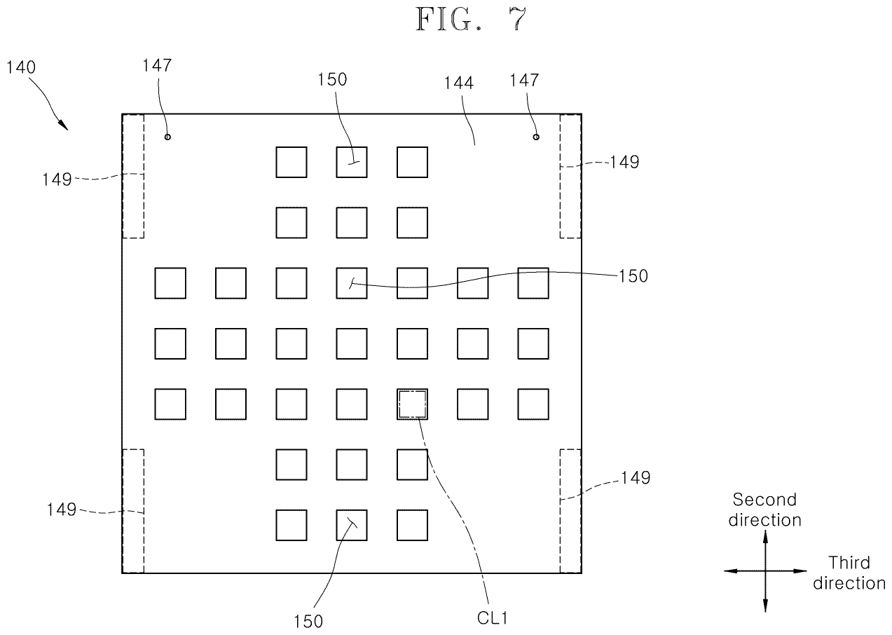

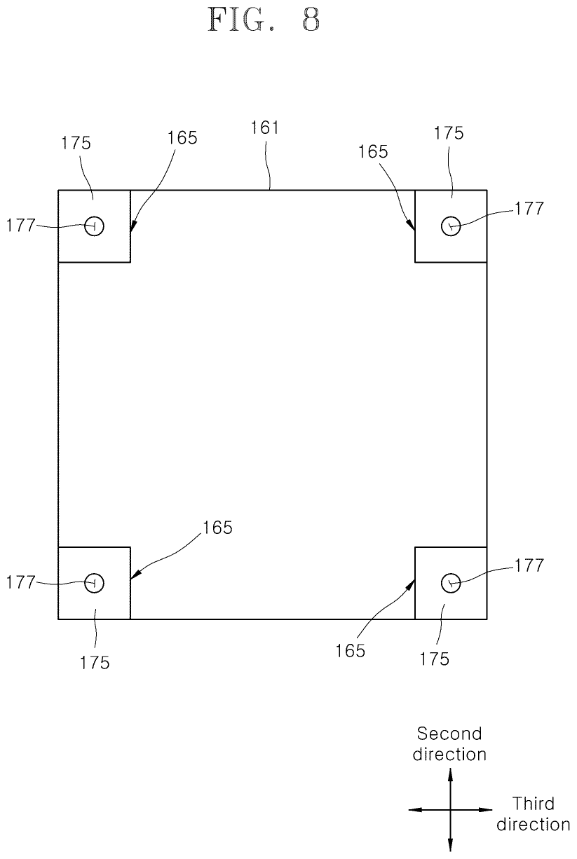

FIG. 1 is a side view of an apparatus for laser notching secondary battery electrodes according to an embodiment of the present disclosure, showing a first plate, a second plate, and a secondary battery electrode spaced apart from one another; FIG. 2 is a cross-sectional view taken along the line II-II of FIG. 1, showing the second plate placed on the first plate with the secondary battery electrode interposed therebetween; FIG. 3 is a cross-sectional view taken along the line III-III of FIG. 1, showing the second plate placed on the first plate with the secondary battery electrode interposed therebetween; FIG. 4 is a plan view of a first plate included in a jig for laser notching of secondary battery electrodes according to an embodiment of the present disclosure; FIG. 5 is a bottom view of the first plate shown in FIG. 4; FIG. 6 is a plan view of a second plate included in the jig for laser notching of secondary battery electrodes according to an embodiment of the present disclosure; FIG. 7 is a bottom view of the second plate shown in FIG. 6; and FIG. 8 is a plan view of a base included in the jig for laser notching of secondary battery electrodes according to an embodiment of the present disclosure, with a scrap tray removed therefrom.

Referring to FIG. 1 to FIG. 8, a secondary battery electrode manufacturing apparatus 100A according to an embodiment of the present disclosure is an apparatus for notching a non-coated portion of a secondary battery electrode 1 by irradiating the non-coated portion with a laser beam, and includes a laser head 103 and a jig for laser notching of secondary battery electrodes 110A. The laser head 103 projects a laser beam L toward the secondary battery electrode 1 to perform notching of the secondary battery electrode 1 in a pattern (e.g., a predetermined pattern).

The jig 110A is a jig for laser notching of secondary battery electrodes according to an embodiment of the present disclosure, and includes a first plate 111 and a second plate 140. The first plate 111 supports the secondary battery electrode 1.

The second plate 140 overlaps the first plate 111 with the secondary battery electrode 1 interposed therebetween to press the secondary battery electrode 1 toward the first plate 111. The second plate 140 has a laser passage through which the secondary battery electrode 1 is partially exposed to allow the laser beam L projected from the laser head 103 to be delivered to the secondary battery electrode 1 therethrough.

The first plate 111, the secondary battery electrode 1, and the second plate 140 may be disposed to overlap each other in a first direction. The laser head 103 may be spaced apart from the jig 110A. The laser head 103 may be spaced apart from the second plate 140 in the first direction.

The laser head 103 may be moved in a direction approaching the first plate 111 and in another direction away from the first plate 111 in the first direction such that a gap DS1 between the first plate 111 and the laser head 103 is adjusted. Accordingly, the location of the laser head 103 in the first direction may be suitably adjusted to allow the laser beam L projected from the laser head 103 to be focused on the secondary battery electrode 1 such that the secondary battery electrode 1 may be cut smoothly thereby.

For example, the first direction may be a vertical direction. Second and third directions may be horizontal directions orthogonal to the first direction. The second and third directions may be orthogonal to each other.

In an embodiment, the first plate 111 is a plate-shaped member having a constant thickness in the first direction. The first plate 111 includes an electrode support surface 112 on which the secondary battery electrode 1 is brought into contact with and supported. In the embodiment of FIG. 1, the electrode support surface 112 may be an upper surface facing upward, and an opposite surface 115 to the electrode support surface 112 may be a lower surface facing downward.

In an embodiment, the second plate 140 is a plate-shaped member having a constant thickness in the first direction. The second plate 140 includes an electrode compressing surface 144 that faces and compresses the secondary battery electrode 1. In the embodiment shown in FIG. 1, the electrode compressing surface 144 may be a lower surface facing downward, and an opposite surface 142 to the electrode compressing surface 144 may be an upper surface facing upward. The upper surface 142 of the second plate 140 faces the laser head 103.

The laser beam L projected from the laser head 103 may be incident on the upper surface 142 of the second plate 140. The laser beam L projected from the laser head 103 may be delivered to the secondary battery electrode 1 through the laser passage.

The laser passage may include a laser aperture 150 that penetrates the second plate 140 in a thickness direction thereof. The laser aperture 150 may have a closed curve planar shape CL1. For example, the planar shape CL1 of the laser aperture 150 may be a rectangular shape as shown in FIG. 6 and FIG. 7. However, the closed curve shape of the laser aperture 150 is not limited thereto and may have any other suitable shape, such as a circular shape, an elliptical shape, a triangular shape, and the like. In an embodiment, the laser aperture 150 may be provided in plural.

The first plate 111 may be formed with first plate apertures 130 aligned with the laser passage and penetrating the first plate 111 in a thickness direction thereof. The first plate apertures 130 may be aligned with the laser apertures 150 in the first direction. In an embodiment, a planar shape CL1 of the first plate apertures 130 may be the same as the planar shape CL1 of the laser apertures 150.

In an embodiment, the first plate apertures 130 may correspond one-to-one to the laser apertures 150 and a number of first plate apertures 130 may be the same as the number of laser apertures 150. When the first plate 111 and the second plate 140 are pressed against each other with the secondary battery electrode 1 interposed therebetween, the laser beam L may be projected into the laser aperture 150 from the laser head 103.

The laser beam L having passed through the laser aperture 150 may be delivered to the secondary battery electrode 1 along the planar shape CL1 of the laser apertures 150. Accordingly, the secondary battery electrode 1 may be cut by the laser beam L into a shape, such as the planar shape CL1 of the laser aperture 150, to form scraps 5. The scraps 5 separated from the secondary battery electrode 1 may be discharged from the first plate 111 through the first plate apertures 130.

Formation and discharge of the scraps 5 from the first plate 111 may mean that the power of the laser beam L for laser notching of the secondary battery electrode 1 and the gap DS1 between the laser head 103 and the first plate 111 are suitable.

Without the first plate aperture 130, the high-power laser beam L delivered to the electrode support surface 112 through the secondary battery electrode 1 might damage the electrode support surface 112 and cause reduction in durability of the first plate 111.

In an embodiment, the first plate 111 and the second plate 140 may be made of a metallic material. For example, the second plate 140 may be made of steel, which has a high specific gravity and good strength and is ferromagnetic. In an embodiment, the first plate 111 may be made of aluminum or an aluminum alloy, which has a lower specific gravity than steel.

The first plate 111 may include a plurality of guide pins 120 protruding toward the second plate 140. The guide pins 120 may protrude upward from the electrode support surface 112 of the first plate 111. The second plate 140 may be formed with a plurality of guide apertures 147 (e.g., through-holes), into which the guide pins 120 are fitted, or inserted, when the first plate 111 and the second plate 140 overlap each other.

When the first plate 111 and the second plate 140 overlap each other such that the plurality of guide pins 120 is fitted into the plurality of guide apertures 147, the first plate apertures 130 of the first plate 111 may be aligned with the laser apertures 150 of the second plate 140 in the first direction.

In another embodiment, unlike the embodiment shown in FIG. 1, FIG. 4, and FIG. 7, the second plate 140 may be formed with a plurality of guide grooves into which the plurality of guide pins 120 is fitted, instead of the guide holes 147. In another embodiment, the second plate 140 may be formed with a plurality of guide pins and the first plate 111 may be formed with a plurality of guide holes or a plurality of guide grooves, into which the plurality of guide pins is fitted.

The second plate 140 may include a gripping portion 149 that protrudes outward beyond a boundary of an outer circumference of the first plate 111 to be gripped by an operator upon separation of the second plate 140 from the first plate 111. The gripping portion 149 may be provided in plural to allow the operator to grip the second plate 140 with both hands.

The gripping portion 149 may protrude in a direction orthogonal to the first direction. In an embodiment, the second plate 140 may have a rectangular planar shape, and the first plate 111 may have a stepped planar shape with a plurality of portions stepwise cut from the rectangular shape of the second plate 140.

Due to a plurality of stepped cut surfaces 122 formed on the first plate 111, a plurality of gripping portions 149 protruding outward beyond an outer surface of the first plate 111 may be formed when the first plate 111 and the second plate 140 overlap each other. With the first plate 111 and the second plate 140 overlapping each other, an operator can easily separate the second plate 140 from the first plate 111 by holding the gripping portions 149 and lifting the second plate 140.

In an embodiment, the first plate 111 may include a magnet 125 and the second plate 140 may be made of a ferromagnetic material, for example, steel. The magnet 125 may be disposed on the electrode support surface 112 so as not to protrude above the electrode support surface 112 of the first plate 111. The magnet 125 may be provided in plural.

Accordingly, when the second plate 140 is placed on the first plate 111, the second plate 140 may be pulled toward the first plate 111, whereby the first plate 111 and the second plate 140 can be pressed against each other, with the secondary battery electrode 1 interposed therebetween. In another embodiment, unlike the embodiment shown in FIG. 1, FIG. 2, and FIG. 4 to FIG. 7, the magnets may be disposed on the second plate 140 and the first plate 111 may be made of a ferromagnetic material.

The jig 110A may further include a base 160A supporting the first plate 111 and a fastening bolt 185 coupling the base 160A to the first plate 111. The base 160A may include a plurality of spacers 165, a spacer support 161, and a scrap tray 180.

The spacer support 161 is a substantially plate-shaped member and supports the plurality of spacers 165. The spacer support 161 may be supported on, for example, a floor. The plurality of spacers 165 supports the first plate 111 and is fixedly supported by the spacer support 161.

In an embodiment, each of the spacers 165 extends to have a constant length in the first direction. The spacer 165 may include a lower portion 170 located near the spacer support 161 in the first direction and contacting the spacer support 161, an upper portion 175 located near the first plate 111 in the first direction and contacting the first plate 111, and a middle portion 167 connecting the lower portion 170 to the upper portion 175.

In an embodiment, the base 160A may be provided with four spacers 165 to provide stable four-point support with respect to the first plate 111. However, a number of the spacers 165 is not limited thereto and may be set in various ways, for example, one, two, three, six, etc.

The first plate 111 may be formed with a plurality of spacer seating grooves 117 in which the plurality of spacers 165 is seated. The spacer seating grooves 117 may be stepped grooves formed on a lower surface 115 of the first plate 111. The number of spacer seating grooves 117 may be the same as the number of spacers 165.

The fastening bolts 185 couple the plurality of spacers 165 to the first plate 111. In an embodiment, the fastening bolt 185 may be provided in plural so as to have one-to-one correspondence with the spacers 165. Each of the fastening bolts 185 may include a bolt body 186 and a bolt head 189. The bolt body 186 extends in the first direction.

The bolt body 186 may penetrate the first plate 111 in the thickness direction thereof, that is, in the first direction, and may have a first end inserted into the spacer 165. A lower end of the bolt body 186 may be inserted into and engage with an upper portion 175 of the spacer 165 seated in the spacer seating groove 117.

The upper portion 175 of the spacer 165 may be formed with a bolt fastening hole 177 into which the bolt body 186 is inserted, and the first plate 111 may be formed with a bolt aperture 118 through which the bolt body 186 passes. The bolt body 186 may be formed on an outer circumferential surface thereof with a male thread pattern and the bolt hole 177 may be formed on an inner circumferential surface thereof with a female thread pattern that engages with the male thread pattern.

The bolt head 189 is formed at a second end, that is, an upper end, of the bolt body 186 and has a greater diameter than the bolt body 186. The electrode support surface 112 of the first plate 111 is formed with a stepped bolt head seating groove 113.

When the bolt body 186 penetrates the bolt aperture 118 and the bolt head 189 is seated in the bolt head seating groove 113, the bolt head 189 does not contact the secondary battery electrode 1 supported on the electrode support surface 112. Accordingly, when the first plate 111 and the second plate 140 are pressed against each other with the secondary battery electrode 1 interposed therebetween, the secondary battery electrode 1 does not contact the fastening bolt 185.

Although not clearly shown in FIG. 1, the lower portion 170 of the spacer 165 may also be coupled to the spacer support 161 by a fastening bolt (not shown). Like the upper portion of the spacer, the lower portion of the spacer 165 may also be formed with a bolt fastening hole (not shown) that engages with the fastening bolt.

The scrap tray 180 may collect the scraps 5, which are cut from the secondary battery electrode 1 by the laser beam L emitted from the laser head 103 to the secondary battery electrode 1 and are discharged from the first plate 111 through the first plate aperture 130. An operator may determine whether an operation of notching the secondary battery electrode 1 is normally performed based on a condition of the scraps 5 that fall into the scrap tray 180.

The scrap tray 180 may be disposed under the first plate 111 to overlap the first plate 111. In an embodiment, the scrap tray 180 may be detachably supported on the spacer support 161. In other embodiments, the scrap catcher 180 may be detachably supported on the plurality of spacers 165 or may be detachably supported on the spacer support 161 and the plurality of spacers 165.

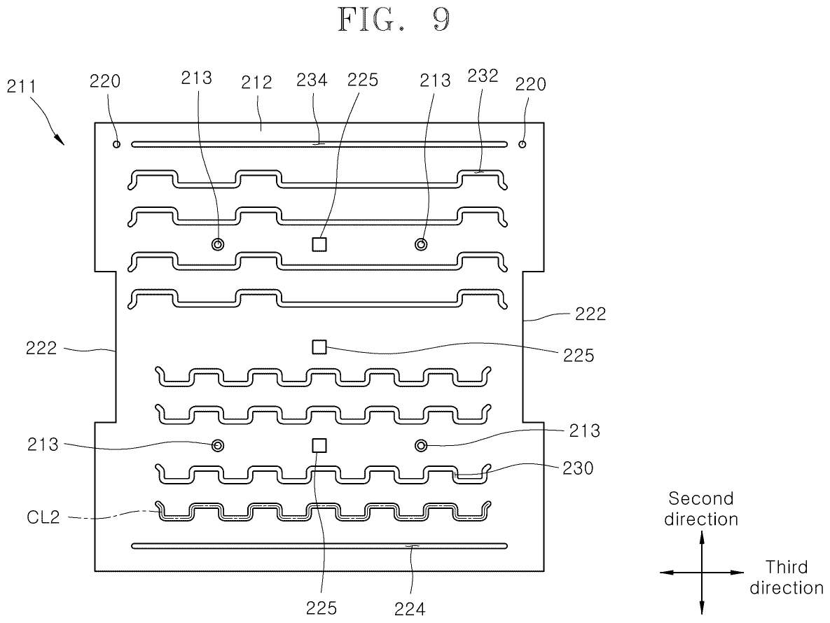

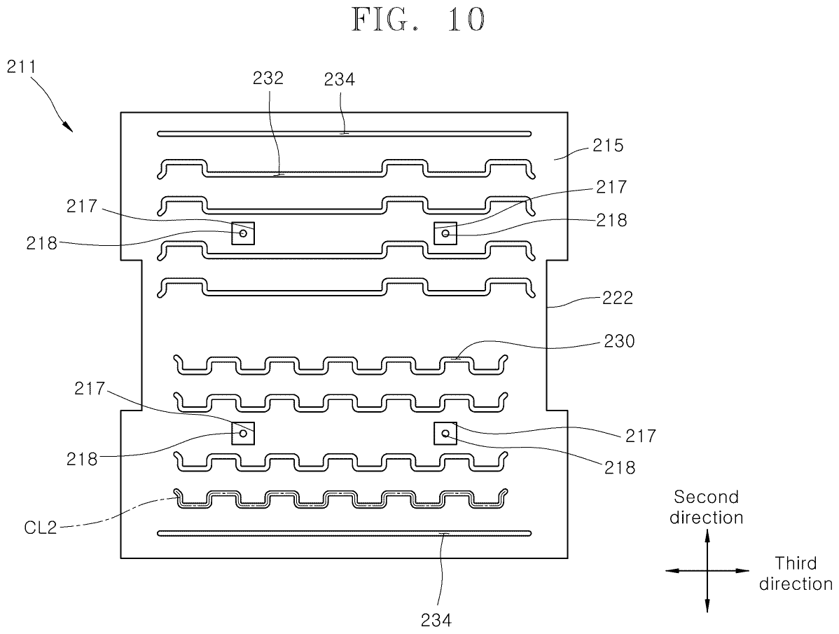

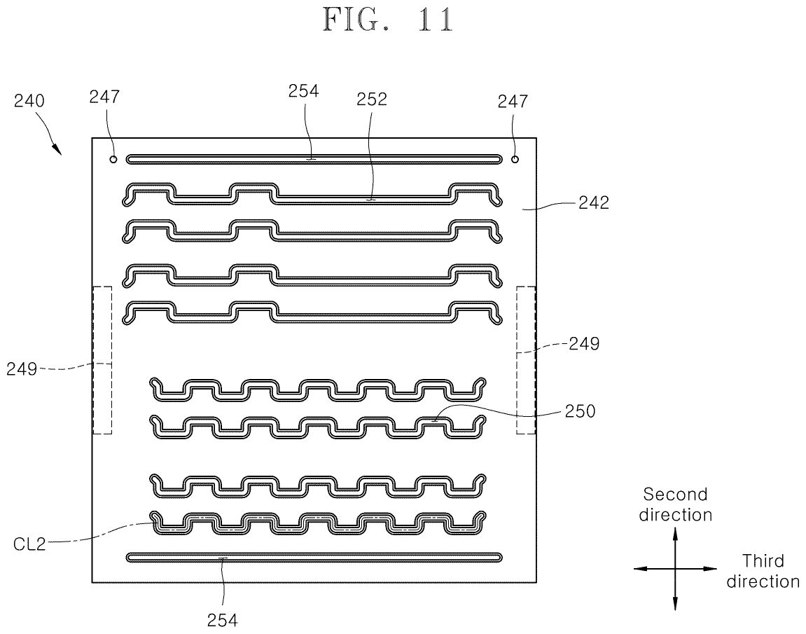

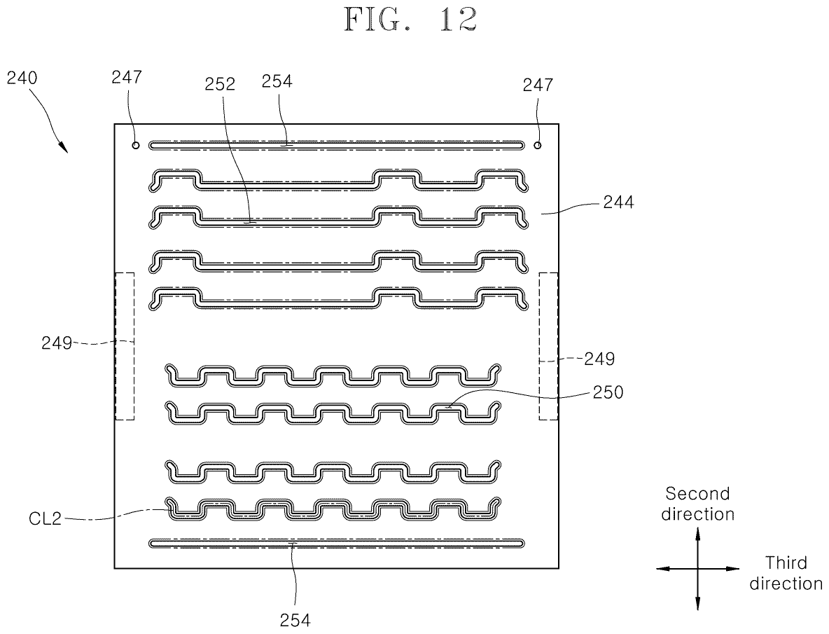

FIG. 9 is a plan view of a first plate included in a jig for laser notching of secondary battery electrodes according to another embodiment of the present disclosure; FIG. 10 is a bottom view of the first plate shown in FIG. 9; FIG. 11 is a plan view of a second plate included in the jig for laser notching of secondary battery electrodes according to the embodiment of FIG. 9; and FIG. 12 is a bottom view of the second plate shown in FIG. 11.

Referring to FIG. 1 and FIG. 9 to FIG. 12, the apparatus for laser notching of secondary battery electrodes 100A shown in FIG. 1 may be provided with a first plate 211 shown in FIG. 9 and FIG. 10 instead of the first plate 111 shown in FIG. 4 and FIG. 5. In addition, the apparatus for laser notching of secondary battery electrodes 100A may be provided with a second plate 240 shown in FIG. 11 and FIG. 12 instead of the second plate 140 shown in FIG. 6 and FIG. 7.

The first plate 211 supports a secondary battery electrode 1. The second plate 240 overlaps the first plate 211 with the secondary battery electrode 1 interposed therebetween and presses the secondary battery electrode 1 toward the first plate 211. The second plate 240 includes a laser passage through which the secondary battery electrode 1 is partially exposed to allow the laser beam L projected from the laser head 103 to be delivered to the secondary battery electrode 1 therethrough.

The first plate 211, the secondary battery electrode 1, and the second plate 240 may be disposed to overlap each other in the first direction. In an embodiment, the first plate 211 is a plate-shaped member having a constant thickness in the first direction. The first plate 211 includes an electrode support surface 212 on which the secondary battery electrode 1 is brought into contact with and supported. The electrode support surface 212 may be an upper side facing upward, and an opposite side 215 of the electrode support surface 212 may be a lower side facing downward.

In an embodiment, the second plate 240 is a plate-shaped member having a constant thickness in the first direction. The second plate 240 includes an electrode compressing surface 244 that faces and compresses the secondary battery electrode 1. The electrode compressing surface 244 may be a lower surface facing downward, and an opposite surface to the electrode compressing surface 244 may be an upper surface 242 facing upward. The upper surface 242 of the second plate 240 faces the laser head 103.

The laser beam L projected from the laser head 103 may be incident on the upper surface 242 of the second plate 240. The laser beam L projected from the laser head 103 may be delivered to the secondary battery electrode 1 through the laser passage.

The laser passage may include laser apertures 250, 252, 254 that penetrate the second plate 240 in a thickness direction thereof. In an embodiment, the laser apertures 250, 252, 254 may have a line shape CL2 extending in a plane having a constant width and orthogonal to the first direction in a plan view.

The laser apertures 250, 252, 254 may be categorized into a plurality of types depending on the line shape thereof. For example, the line shape of first laser apertures 250 may be a regular dent pattern in which grooves and protrusions are regularly arranged at constant intervals. The line shape of second laser apertures 252 may be an irregular dent pattern in which protrusions are arranged at irregular intervals. The line shape of third laser apertures 254 may be a straight line shape.

The first plate 211 may be formed with first plate apertures 230, 232, 234 aligned with the laser passage and penetrating the first plate 211 in a thickness direction thereof. The first plate apertures 230, 232, 234 may be aligned with the laser apertures 250, 252, 254 in the first direction. In an embodiment, a planar shape CL2 of the first plate apertures 230, 232, 234 may be the same as the planar shape CL2 of the laser apertures 250, 252, 254.

In an embodiment, the first plate apertures 230, 232, 234 may correspond one-to-one to the laser apertures 250, 252, 254 and a number of first plate apertures 230, 232, 234 may be the same as a number of laser apertures 250, 252, 254. When the first plate 211 and the second plate 240 are pressed against each other with the secondary battery electrode 1 interposed therebetween, the laser beam L may be projected into the laser apertures 250, 252, 254 from the laser head 103.

The laser beam L having passed through the laser apertures 250, 252, 254 may be delivered to the secondary battery electrode 1 along the planar shape CL2 of the laser apertures 250, 252, 254. Accordingly, the secondary battery electrode 1 may be cut by the laser beam L into a shape, such as the planar shape CL2 of the laser apertures 250, 252, 254.

Without the first plate apertures 230, 232, 234, the high-power laser beam L might be delivered to the electrode support surface 212 through the secondary battery electrode 1, thus damaging to the electrode support surface 212 and causing reduction in durability of the first plate 211.

In an embodiment, the first plate 211 and the second plate 240 may be made of a metallic material. For example, the second plate 240 may be made of steel, which has a high specific gravity and good strength and is ferromagnetic. In an embodiment, the first plate 211 may be made of aluminum or an aluminum alloy, which has a lower specific gravity than steel.

The first plate 211 may include a plurality of guide pins 220 protruding toward the second plate 240. The guide pins 220 may protrude upward from the electrode support surface 212 of the first plate 211. The second plate 240 may be formed with a plurality of guide apertures 247 (e.g., through-holes), into which the guide pins 220 are fitted, or inserted, when the first plate 211 and the second plate 240 overlap each other.

When the first plate 211 and the second plate 240 overlap each other such that the plurality of guide pins 220 is fitted into the plurality of guide apertures 247, the first plate apertures 230, 232, 234 of the first plate 211 may be aligned with the laser apertures 250, 252, 254 of the second plate 240 in the first direction, respectively.

In another embodiment, unlike the embodiment shown in FIG. 9 to FIG. 12, the second plate 240 may be formed with a plurality of guide grooves into which the plurality of guide pins 220 is fitted, instead of the guide apertures 247. In another embodiment, the second plate 240 may be formed with a plurality of guide pins and the first plate 211 may be formed with a plurality of guide holes or a plurality of guide grooves, into which the plurality of guide pins is fitted.

In an embodiment, the second plate 240 may include a gripping portion 249 that protrudes outwards beyond a boundary of an outer circumference of the first plate 211 to be gripped by an operator upon separation of the second plate 240 from the first plate 211. The gripping portion 249 may be provided in plural to allow the operator to grip the second plate 240 with both hands.

The gripping portion 249 may protrude in a direction orthogonal to the first direction. In an embodiment, the second plate 240 may have a rectangular planar shape and the first plate 211 may have a planar shape with a plurality of portions stepwise cut from the rectangular shape of the second plate 240.

Due to a plurality of stepped cut surfaces 222 formed on the first plate 211, a plurality of gripping portions 249 protruding outwards beyond an outer surface of the first plate 211 may be formed when the first plate 211 and the second plate 240 overlap each other. With the first plate 211 and the second plate 240 overlapping each other, an operator can easily separate the second plate 240 from the first plate 211 by holding the gripping portions 249 and lifting the second plate 240.

In an embodiment, the first plate 211 may include a magnet 225 and the second plate 240 may be made of a ferromagnetic material, for example, steel. The magnet 225 may be disposed on the electrode support surface 212 so as not to protrude above the electrode support surface 212 of the first plate 211. The magnet 225 may be provided in plural.

Accordingly, when the second plate 240 is placed on the first plate 211, the second plate 240 may be pulled toward the first plate 211, whereby the first plate 211 and the second plate 240 can be pressed against each other, with the secondary battery electrode 1 interposed therebetween. In another embodiment, unlike the embodiment shown in FIG. 9 to FIG. 12, the magnets may be disposed on the second plate 240, and the first plate 211 may be made of a ferromagnetic material.

The first plate 211 may be formed with a plurality of spacer seating grooves 217 in which the plurality of spacers 165 is seated. The spacer seating grooves 217 may be stepped grooves formed on a lower surface 215 of the first plate 211. The number of spacer seating grooves 217 may be the same as the number of spacers 165.

The electrode support surface 212 of the first plate 211 is formed with a stepped bolt head seating groove 213. When the bolt body 186 (see FIG. 3) of the fastening bolt 185 (see FIG. 3) penetrates a bolt aperture 218 of the first plate 211 and the bolt head 189 (see FIG. 3) of the fastening bolt 185 is seated in a bolt head seating groove 213, the bolt head 189 does not contact the secondary battery electrode 1 supported on the electrode support surface 112. Accordingly, when the first plate 211 and the second plate 240 are pressed against each other with the secondary battery electrode 1 interposed therebetween, the secondary battery electrode 1 does not contact the fastening bolt 185.

A method for laser notching secondary battery electrodes according to an embodiment of the present invention includes an electrode notching jig preparation step, a secondary battery electrode mounting step, and a laser projection step. The electrode notching jig preparation step is a step of preparing a jig for laser notching of secondary battery electrodes, which includes a first plate 111; 211 and a second plate 140; 240. The second plate 140; 240 is provided with a laser passage.

The laser passage may include laser apertures 150; 250, 252, 254 that penetrate the second plate 140; 240 in the thickness direction thereof. The first plate 111; 211 and the second plate 140; 240 have been described above with reference to FIG. 4 to FIG. 7 and FIG. 9 to FIG. 12, and repeated descriptions thereof may be omitted.

In the secondary battery electrode mounting step, a secondary battery electrode 1 (see FIG. 1) is interposed between the first plate 111; 211 and the second plate 140; 240 and is mounted on the jig such that the first plate 111; 211, the secondary battery electrode 1 (see FIG. 1), and the second plate 140; 240 overlap each other. The secondary battery electrode 1 is pressed so as not to be bent between the first plate 111; 211 and the second plate 140; 240. The secondary battery electrode 1 may be partially exposed through the laser passage such that at least a part thereof can be visible outside the second plate 140; 240.

The laser projection step is a step of projecting a laser beam L (see FIG. 1) toward the second plate 140; 240 such that the secondary battery electrode 1 is irradiated with the laser beam L through the laser passage. The laser beam L projected from the laser head 103 (see FIG. 1) may be incident on an upper surface 142; 242 of the second plate 140; 240 to be delivered to the secondary battery electrode 1 through the laser passage.

When the laser beam L is projected from the laser head 103 so as to pass through at least one of the plurality of laser apertures 150; 250, 252, 254, the secondary battery electrode 1 may be cut by laser notching. After the laser projection step, when the second plate 140; 240 is separated from the first plate 111; 211, the notched secondary battery electrode 1 can be removed from the jig.

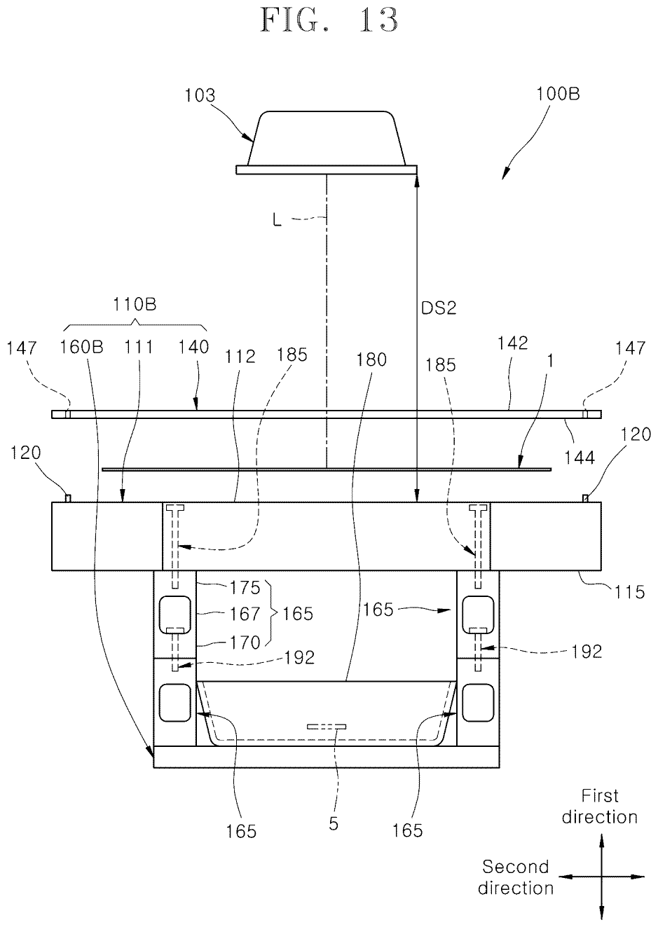

FIG. 13 is a side view of an apparatus for laser notching secondary battery electrodes according to another embodiment of the present disclosure, showing a first plate, a second plate, and a secondary battery electrode spaced apart from one another. Referring to FIG. 13, an apparatus for laser notching secondary battery electrodes 100B according to another embodiment of the present disclosure is an apparatus for notching a non-coated portion of a secondary battery electrode 1 by irradiating the non-coated portion with a laser beam and includes a laser head 103 and a jig for laser notching of secondary battery electrodes 110B.

The jig 110B includes a first plate 111, a second plate 140, and a base 160B. The laser head 103, the first plate 111, and the second plate 140 may be the same as the corresponding components of the apparatus for laser notching secondary battery electrodes 100A according to the above-described embodiment and are denoted by the same reference numerals. Therefore, repeated descriptions of the laser head 103, the first plate 111 and the second plate 140 may be omitted.

The base 160B supports the first plate 111 and may include a plurality of spacers 165, a spacer support 161, and a scrap tray 180. The spacers 165, the spacer support 161, and the scrap tray 180 may be the same as the corresponding components of the apparatus for laser notching secondary battery electrodes 100A according to the above-described embodiment and are denoted by the same reference numerals. Accordingly, repeated descriptions of the spacers 165, the spacer support 161, and the scrap tray 180 may be omitted.

However, unlike the base 160A shown in FIG. 1, the spacers 165 are provided in a total of eight and the eight spacers 165 are arranged in pairs to overlap along a straight line parallel to a direction in which the first plate 111, the secondary battery electrode 1, and the second plate 140 overlap. In an embodiment, the eight spacers 165 are arranged in pairs so as to overlap in the first direction.

In each pair of spacers 165 overlapping each other, one spacer 165 having an upper portion 175 contacting a lower surface 115 of the first plate 111 may be coupled to the first plate 111 by a fastening bolt 185. The fastening bolt 185 may be the same as the fastening bolt 185 described with reference to FIG. 1 and FIG. 3 and is denoted by the same reference numeral, and a repeated description thereof will be omitted.

Among the pair of spacers 165 overlapping each other, a lower portion 170 of a first spacer 165 may be coupled to the upper portion 175 of a second spacer 165 by a different type of fastening bolt 192 that is shorter than the fastening bolt 185. Although not clearly shown in FIG. 13, a lower portion 170 of the second spacer 165 among the pair of spacers 165 overlapping each other may be coupled to the spacer support 161 by a fastening bolt (not shown).

In the apparatus for laser notching secondary battery electrodes 100B shown in FIG. 13, the multiple spacers 165 are stacked to overlap each other in the first direction, whereby a gap DS2 between the first plate 111 and the laser head 103 can be narrowed to a large extent, as compared with the gap DS1 between the first plate 111 and the laser head 103 in the apparatus for laser notching secondary battery electrodes 100A shown in FIG. 1.

Although FIG. 13 shows an embodiment with a pair of spacers 165 overlapping each other, it is to be understood that three or four spacers 165, for example, may be stacked to overlap each other. By changing the number of spacers 165 stacked to overlap each other, an operator can adjust a gap between the first plate 111 and the laser head 103 to a large extent and can finely adjust the gap between the first plate 111 and the laser head 103 by moving the laser head 103 in the first direction.

Although the present disclosure has been described above with respect to some embodiments thereof, the present disclosure is not limited thereto. Various modifications and variations can be made thereto by those skilled in the art within the spirit of the present disclosure and the equivalent scope of the appended claims.

What is claimed is:

1. A jig for laser notching of secondary battery electrodes, the jig comprising:
a first plate to support a secondary battery electrode; and
a second plate overlapping the first plate to press the secondary battery electrode therebetween toward the first plate, the second plate comprising a laser passage to partially expose the secondary battery electrode to allow a laser beam to be delivered to the secondary battery electrode therethrough.

2. The jig as claimed in claim 1, further comprising:
a base comprising at least one spacer supporting the first plate and a spacer support supporting the at least one spacer.

3. The jig as claimed in claim 2, further comprising:
at least one fastening bolt coupling the at least one spacer to the first plate,
wherein the secondary battery electrode does not contact the fastening bolt when the secondary battery electrode is arranged between the first plate and the second plate.

4. The jig as claimed in claim 3, wherein
the fastening bolt comprises a bolt body penetrating the first plate in a thickness direction thereof and having a first end inserted in the spacer, and a bolt head at a second end of the bolt body and having a greater diameter than the bolt body,
the first plate comprises an electrode support surface with which the secondary battery electrode is contactable, and
a bolt head seating groove is located on the electrode support surface to allow the bolt head to be seated therein so as not to contact the secondary battery electrode.

5. The jig as claimed in claim 2, wherein the first plate comprises at least one spacer seating groove in which the at least one spacer is seated.

6. The jig as claimed in claim 2, wherein the at least one spacer comprises a plurality of spacers arranged to overlap each other along a straight line parallel to a direction in which the first plate, the secondary battery electrode, and the second plate overlap one above another.

7. The jig as claimed in claim 2, wherein the first plate comprises a first plate aperture aligned with the laser passage and penetrating the first plate in a thickness direction thereof.

8. The jig as claimed in claim 7, wherein the base further comprises a scrap tray to collect scraps cut from the secondary battery electrode and discharged from the first plate through the first plate aperture, the scrap tray being detachably supported on the spacer support or the at least one spacer.

9. The jig as claimed in claim 1, wherein the laser passage comprises a laser aperture penetrating the second plate in a thickness direction thereof.

10. The jig as claimed in claim 9, wherein the laser aperture has a closed curve planar shape.

11. The jig as claimed in claim 9, wherein the laser aperture has a line shape extending with a constant width in a plan view.

12. The jig as claimed in claim 9, wherein the first plate is formed with a first plate aperture aligned with the laser aperture and penetrating the first plate in a thickness direction thereof, and the first plate aperture has a same planar shape as the laser aperture.

13. The jig as claimed in claim 1, wherein, if the second plate is placed on the first plate, the second plate is pulled toward the first plate.

14. The jig as claimed in claim 13, wherein one of the first plate and the second plate comprises a magnet, and the other of the first plate and the second plate comprises a ferromagnetic material.

15. The jig as claimed in claim 1, wherein one of the first plate and the second plate comprises a plurality of guide pins protruding therefrom toward the other of the first plate and the second plate, and the other of the first plate and the second plate is formed with a plurality of guide apertures or a plurality of guide grooves into which the plurality of guide pins is inserted when the first plate and the second plate overlap each other.

16. The jig as claimed in claim 1, wherein the second plate comprises a gripping portion protruding outward beyond a boundary of an outer circumference of the first plate to be gripped upon separation of the second plate from the first plate.

17. An apparatus for laser notching secondary battery electrodes, the apparatus comprising:
a jig comprising a first plate to support a secondary battery electrode, and a second plate overlapping the first plate to press the secondary battery electrode therebetween toward the first plate, the second plate comprising a laser passage to partially expose the secondary battery electrode; and
a laser head configured to project a laser beam toward the second plate to be delivered to the secondary battery electrode through the laser passage.

18. The apparatus as claimed in claim 17, wherein the jig further comprises: at least one spacer supporting the first plate to allow a gap between the first plate and the laser head to be adjusted; and a spacer support supporting the at least one spacer.

19. The apparatus as claimed in claim 17, wherein the laser head is movable in a direction approaching the first plate and in another direction away from the first plate such that a gap between the first plate and the laser head is adjusted.

20. A method for laser notching secondary battery electrodes, the method comprising:
preparing a jig for laser notching of secondary battery electrodes, the jig comprising a first plate and a second plate having a laser passage;
arranging a secondary battery electrode between the first plate and the second plate and mounting the secondary battery electrode on the jig such that the first plate, the secondary battery electrode, and the second plate overlap one another; and
projecting a laser beam toward the second plate to be delivered to the secondary battery electrode through the laser passage.
